(19) United States
(12) Patent Application Publication
(10) Pub. No.: US 2006/0197049 A1
(43) Pub. Date: Sep. 7, 2006

(54) Fluid operating valve

(76) Inventors: Takeshi Hamada, Miyazaki (JP); Toshihiro Hanada, Miyazaki (JP)

Correspondence Address: BUCHANAN INGERSOLL PC, POST OFFICE BOX 1404, ALEXANDRIA, VA, 22313-1404, US

(21) Appl. No.: 10/551,716

(22) PCT Filed: Mar. 8, 2004
(86) PCT No.: PCT/JP04/02975

§ 371 Date: Oct. 3, 2005

(30) Foreign Application Priority Data
Apr. 3, 2003 (JP) 2003-100704

(51) Int. Cl. F16K 51/00

(52) U.S. Cl. 251/285

(57) ABSTRACT

A fluid-operated valve comprises a first valve chamber (16) and a second valve chamber (25) communicating with each other through a through-hole (21), a first cylinder chamber (39) formed adjacent to the first valve chamber (16) and accommodating a first piston (6) so as to be slidable therein, a valve body (3) positioned in the second valve chamber (25) and adapted to come into contact with or move away from a valve seat (22) around the through-hole (21), a valve stem (4) having one end connected to the first piston (6) and the other end connected to the valve body (3), and an annular diaphragm (8) having an inner peripheral portion fixed to the valve stem (4) and an outer peripheral portion fixed to the inner peripheral surface of the first valve chamber (16). The first piston (6) is urged by a spring (9) to bring the valve body (3) into contact with the valve seat (22). The first piston (6) is moved by supplying the working fluid into the first cylinder chamber (39) through the working fluid supply port of a first cylinder (5) to move the valve body (3) away from the valve seat (22).

### TECHNICAL FIELD

The present invention relates to a fluid-operated valve, having first and second flow passages making up an outlet and an inlet for the fluid, which is used for fluid transportation in various industrial fields, such as chemicals, semiconductor production, food processing, biotechnology and the like.

### BACKGROUND ART

In various conventional chemical liquid lines and pure water lines, as shown in FIG. 6, for example, a method is employed in which, in order to supply a predetermined amount of a fluid into a tank 108 with high accuracy, a plurality of two-way valves 106, 107 of different diameters are disposed in parallel to each other and are opened in the initial stage thereby to fill the tank 108 at a large flow rate, while the large-diameter two-way valve 107 is closed and the small-diameter two-way valve 106 alone is opened in the last stage, thereby finely adjusting the total capacity.

However, this method requires two or more two-way valves to be disposed. Therefore, it has problems of complicating the piping work, requiring a large piping space, and further increasing the cost due to the need of a plurality of valves and the corresponding amount of piping materials.

In order to solve the problems, Japanese Unexamined Patent Publication No. 7-217767, for example, proposes the use of a three-position open-and-close valve as shown in FIG. 7.

Referring to FIG. 7, this three-position open-and-close valve is so configured that when the working fluid (such as a compressed air) is injected from neither a first operating port 117 nor a second operating port 118, a first piston 113 having a valve body 112 at an end thereof is urged away from a valve seat 115 by an urging force of a first return spring 114, and the movement thereof is limited by a limiting rod 116 to thereby maintain the slightly opened state of the valve. When the working fluid is injected from the first operating port 117 but not from the second operating port 118, a first piston 113 is pressed down against the urging force of the first return spring 114, and the valve body 112 is brought into contact with the valve seat 115 to thereby fully close the valve. In contrast, when the working fluid is injected from the second operating port 118 but not from the first operating port 117, a second piston 119 is pressed upward against the urging force of a second return spring 120 and the limiting rod 116 coupled to the second piston 119 is moved upward, so that the limiting of the first piston 113 is released and the valve is fully opened.

An application using this three-position open-and-close valve will be specifically explained. In the case where a predetermined amount of a fluid (such as a chemical liquid) is supplied into the tank, the working fluid is, at the initial stage, not injected from the first operating port 117 but from the second operating port 118 to thereby fully open the valve so that the tank is filled at a high flow rate, while the working fluid is, at the last stage, injected neither from the first operating port 117 nor from the second operating port 118 to thereby open the valve slightly so that the total volume is finely adjusted. Once a predetermined amount of the fluid has been fed, the working fluid is injected from the first operating port 117 but not from the second operating port 118 to thereby fully close the valve so that the fluid is stopped.

However, this three-position open-and-close valve cannot be fully closed in a situation where the working fluid is not injected. This results in a problem that, in the case of emergency where the supply of the working fluid stops, for example, the valve is kept slightly opened and the fluid such as a chemical liquid flowing through the line continues to flow out from the line. Also, this valve has such a structure that, when it is fully closed, the valve seat is pressed down by the valve body from above to thereby stop the fluid supply, and the stopped fluid applies a force in such a direction as to push up the valve body, i.e. in such a direction as to move the valve body away from the valve seat. Therefore, especially in the case where the fluid pressure is high, the force of the fluid pushing up the valve body exceeds the force of the fluid pressing the valve body against the valve seat, thereby resulting in a problem that a leakage is liable to occur.

### DISCLOSURE OF THE INVENTION

An object of the present invention is to obviate the aforementioned problem of the prior art and to provide a fluid-operated valve which has a function to be fully closed in the case of an emergency and is capable of exhibiting a high sealing performance even in a situation where the fluid pressure is high. Another object of the present invention is to provide a fluid-operated valve which has the aforementioned configuration and is capable of adjusting and holding the opening degree of the valve at any of a fully closed state, a fully opened state and an arbitrary intermediate-opening degree.

According to this invention, in order to achieve the objects described above, there is provided a fluid-operated valve including: a valve housing; a first valve chamber and a second valve chamber formed in the valve housing and communicating with each other through a through-hole; a first cylinder chamber formed adjacent to the first valve chamber in the valve housing; a first piston accommodated in the first cylinder chamber so as to be slidable therein; a valve body positioned in the second valve chamber and adapted to come into contact with or move away from the valve seat formed at the edge of the through-hole to thereby establish or shut off communication between the first valve chamber and the second valve chamber; a valve stem extending through the through-hole and the first valve chamber and having one end connected to the first piston and the other end connected to the valve body; an annular diaphragm having an inner peripheral portion fixed to a valve stem and an outer peripheral portion fixed to an inner peripheral surface of the first valve chamber; and a spring for urging the first piston away from the first valve chamber to bring the valve body into contact with the valve seat, wherein, by supplying the working fluid into one of spaces separated from each other in the first cylinder chamber by the first piston which one space is far from the first valve chamber, the first piston is moved toward the first valve chamber to move the valve body away from the valve seat, thereby allowing the fluid to flow between the first valve chamber and the second valve chamber.

In the fluid-operated valve described above, a pressure-receiving area of the diaphragm for receiving the pressure of the fluid in the first valve chamber is preferably designed to be larger for the diaphragm than that of the valve body.

As the first piston is urged away from the first valve chamber by the spring in the fluid-operated valve according to the present invention, the valve body connected to the first piston through the valve stem is pressed against the valve seat to thereby fully close the valve, when the working fluid such as air or oil is not supplied to the fluid-operated valve. As a result, in case of an emergency in which the working fluid is not supplied to the fluid-operated valve, the fluid is prevented from flowing through the valve.

In the fully closed state, the fluid in the first valve chamber applies pressure to both the diaphragm and the valve body. The valve body receives the pressure of the fluid by way of the through-hole, and the opening area of the through-hole becomes substantially equal to the sectional area of the first valve chamber at most. Thus, as the pressure-receiving area of the diaphragm becomes at least equal to the pressure-receiving area of the valve body, the force exerted on the valve body by the fluid in the first valve chamber in a direction to move the valve body away from the valve seat is canceled by the force exerted on the diaphragm by the fluid in the first valve chamber in a direction to press the valve body against the valve seat. Therefore, the force exerted in a direction to move the valve body away from the valve seat cannot exceed the force exerted in a direction to press the valve body against the valve seat.

Especially in the case where a pressure-receiving area of the diaphragm for receiving the pressure of the fluid in the first valve chamber is designed to be larger than that of the valve body, the force exerted in the direction to press the valve body against the valve seat, in the fully closed state, always exceeds the force exerted in the direction to move the valve body away from the valve seat, and therefore a high sealing performance can be exhibited.

In the preferred embodiment of the fluid-operated valve described above, the fluid-operated valve includes a second cylinder chamber formed adjacent to the first cylinder chamber on the side thereof far from the first valve chamber in the valve housing, a second piston accommodated in the second cylinder chamber so as to be slidable therein, and an adjustment screw extending through the second piston and the second cylinder chamber so that one end thereof is positioned in the first cylinder chamber and the other end thereof is positioned outside the valve housing, the adjustment screw mounted on the second piston so that the amount of projection from the second piston can be adjusted, wherein, by supplying the air, oil, etc. into one of spaces separated from each other in the second cylinder chamber by the second piston which one space is far from the first cylinder chamber, the one end of the adjustment screw is brought into contact with the first piston to move the first piston toward the first valve chamber, thereby moving the valve body away from the valve seat.

If the valve is adapted so that the valve body can be moved away from the valve seat by bringing the adjustment screw mounted on the second piston of the second cylinder chamber into contact with the first piston, the valve opening degree can be adjusted by adjusting the amount of projection of the adjustment screw from the second piston, thereby making it possible to adjust the valve to an intermediate opening degree between the fully closed state and the fully opened state. If the other end of the adjustment screw is positioned outside the valve housing, the amount of projection of the adjustment screw from the second piston can be adjusted without disassembling the valve housing, and therefore the valve opening degree can be adjusted more easily.

In a more preferable embodiment of the fluid-operated valve described above, the second valve chamber is formed in the bottom of the valve housing.

If the second valve chamber is formed in the bottom of the valve housing, the need of the piping for connecting the second valve chamber and a tank, etc. can be eliminated when the valve is placed directly on the tank, etc.

### BRIEF DESCRIPTION OF THE DRAWINGS

The above and other objects, features and advantages of the present invention will be made apparent from the following detailed description of the present invention taken in conjunction with the accompanying drawings, in which:

FIG. 1 is a longitudinal sectional view showing the fully closed state of an air-operated valve constituting an example of the fluid-operated valve according to the present invention;

FIG. 2 is a longitudinal sectional view showing the fully opened state of the air-operated valve of FIG. 1;

FIG. 3 is a longitudinal sectional view showing the intermediate-opening degree state of the air-operated valve of FIG. 1;

FIG. 4 is a longitudinal sectional view showing another embodiment of an air-operated value constituting an example of the fluid-operated valve according to the present invention;

FIG. 5 is an outline view showing a line using the air-operated valve shown in FIG. 1 for supplying a chemical liquid to a tank;

FIG. 6 is an outline view showing a line using two conventional two-way valves for supplying a chemical liquid to a tank; and

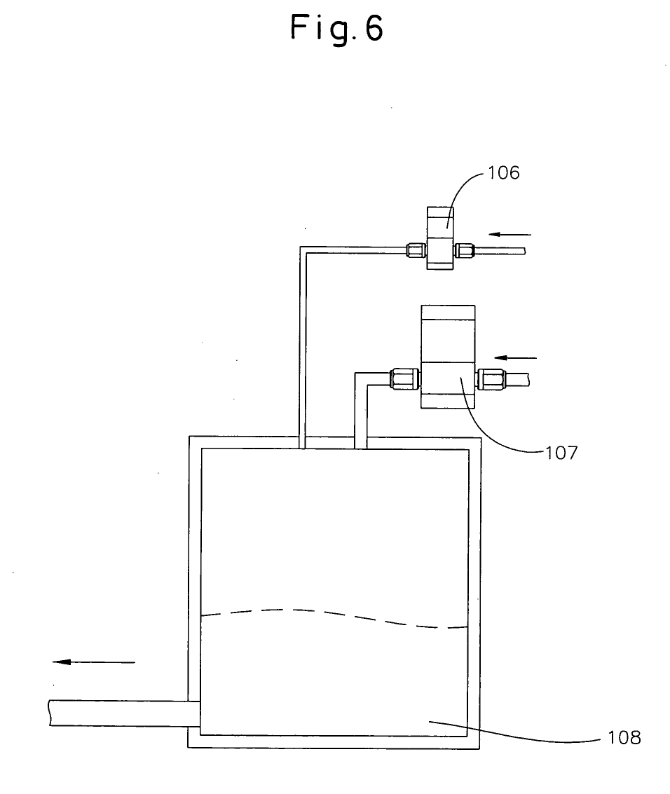

FIG. 7 is a longitudinal sectional view showing a configuration of the conventional three-position open-and-close valve.

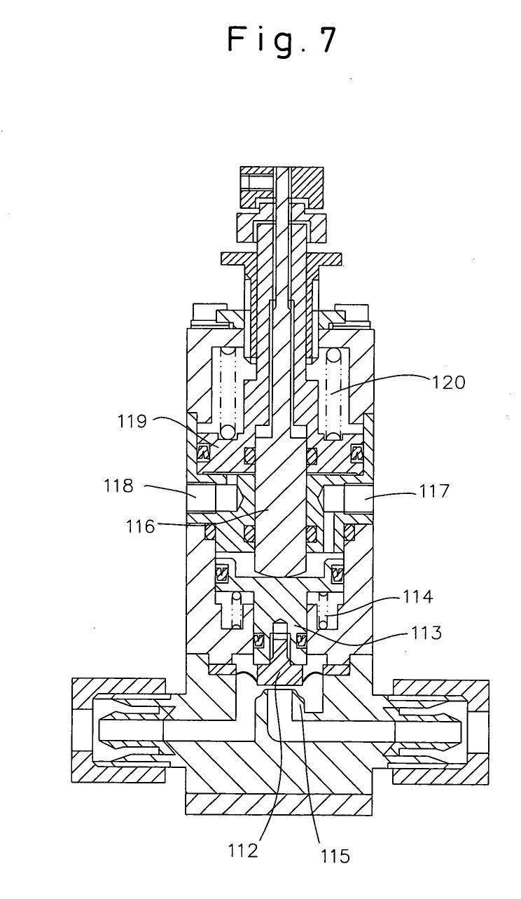

### BEST MODE FOR CARRYING OUT THE INVENTION

Several embodiments of the present invention will be described below with reference to the drawings, but the present invention is, of course, not limited to these embodiments.

An air-operated value 100 includes a valve housing having an upper body 1, a lower body 2, a valve body 3, a first cylinder 5, a second cylinder 10 and a base 15. A substantially bowl-shaped first valve chamber 16 with an open upper side is formed in the upper body 1. A flat portion 17 is formed on the upper body 1 so as surround the outer periphery of the top portion of the first valve chamber 16, and an annular groove 18 is formed on the upper body 1 so as to surround the outer periphery of the flat portion 17. A joint 20 is projected from the side surface of the upper body 1, and a first flow passage 19 formed in the joint 20 is in communication with the first valve chamber 16. A through-hole 21 leading to the first valve chamber 16 is formed in the bottom of the upper body 1, and a valve seat 22 is formed at the lower end of the through-hole 21 to supply or stop the supply of the fluid by the valve body 3 coming into contact with or moving away from the valve seat 22. A recess 23 is formed around the valve seat 22, and an annular groove 24 is formed on the outside of the recess 23.

A second valve chamber 25 having an open upper side and communicating with the through-hole 21 of the upper body 1 is formed in the lower body 2. The second valve chamber 25 has a sufficient space for the valve body 3 to move up and down therein. An annular protrusion 26 for being fixedly fitted in the annular groove 24 of the upper body 1 is formed on the outside of the open upper side of the second valve chamber 25. Also, a joint 28 is projected from the side surface of the lower body 2, and a second flow passage 27 formed in the joint 28 is in communication with the second valve chamber 25.

As described above, in this embodiment, the joints 20, 28 having the first and second flow passages 19, 27 formed therein are integrated with the side surfaces of the upper and lower bodies 1, 2 so as to be projected therefrom. A piping tube 29 is fixed to the joint 20 by fitting a female screw portion 32 of a cap nut 31 on a male screw portion 30 formed on the outer periphery of the joint 20 and fixedly holding, between the outer peripheral surface of the forward end of the joint 20 and the inner peripheral surface of the cap nut 31, an end of the piping tube 29 fitted on the forward end of the joint 20. The piping tube 33 is fixed to the joint 28 in a similar manner. The piping structure of the air-operated valve 100 is not limited to this embodiment and any structure in which the piping is possible can be employed. Also, although, in the embodiment, the joint 20 of the upper body 1 and the joint 28 of the lower body 2 are located on the opposite sides of the longitudinal axis of the air-operated valve 100, their arrangements are not particularly limited, for example, they may alternatively be located on the same side or on the sides facing orthogonally.

The valve body 3 is located in the second valve chamber 25. The diameter of the valve body 3 is larger than that of the through-hole 21 of the upper body 1, so that the valve body 3 may come into contact with or move away from the valve seat 22 formed at the edge of the through-hole 21 of the upper body 1 to thereby supply and stop the supply of the fluid. An opening 34 is formed between the valve seat 22 and the valve body 3 and, by moving the valve body 3 up and down, the area of the opening 34 can be increased and decreased to thereby increase and decrease the flow rate. A valve stem 4 is formed integrally with the valve body 3 at the upper portion of the valve body 3 and inserted into the through-hole 21 of the upper body 1. A male screw portion 35 is formed on the outer periphery of the upper end portion of the valve stem 4, and a flange portion 36 is formed on the outer periphery of the central portion of the valve stem 4. Although the valve body 3 and the valve stem 4 are formed integrally with each other in this embodiment, they may alternatively be formed as separate members and coupled to each other by a screw connection, an adhesive or welding.

The first cylinder 5 is fixed at the upper portion of the upper body 1, and has an upper surface formed with a recess 37. A rectangular through-hole 38 is formed at the central portion of the bottom of the recess 37. In the first cylinder 5, a recess (i.e. the first cylinder chamber) 39 having stepwise increasing diameters is formed, and a first air port 40 communicating with the upper end of the recess 39 is formed on the side surface of the first cylinder 5.

In the first cylinder 5, the first piston 6 is arranged so as to be able to slide vertically along the inner peripheral surface of the first cylinder 5. A flange portion 43 having an annular groove 42 for holding an O-ring 41 is formed on the outer peripheral surface of the upper portion of the first piston 6. On the bottom surface of the first piston 6, a stepwise threaded hole including a female screw portion 44 and a female screw portion 45 of a larger diameter than the female screw portion 44 is formed.

Reference numeral 7 designates a spring support (spring collar), in which a bottomed cylindrical recess 46 is formed. The bottom surface of the spring support 7 is formed in a shape of an inverted bowl, and a through-hole 47 communicating with the recess 46 is formed at the central portion of the same bottom surface. An annular groove 48 is formed on the inner peripheral surface of the through-hole 47, and an O-ring 52 is fitted in the groove 48. The lower portion of the first piston 6 is fitted in the through-hole 47 so as to be vertically slidable. The outer peripheral surface of the lower end portion of the spring support 7 is stepped and inserted into the lower end portion of the recess 39 of the first cylinder 5. An air-vent through-hole 50 for assuring the smooth vertical deflection of the diaphragm 8 is formed on the outside of the through-hole 47 at the central portion of the bottom surface of the spring support 7.

Reference numeral 8 designates a diaphragm, and a through-hole 51 is formed at the center of the diaphragm 8. The inner peripheral surface of the through-hole 51 is formed with an annular groove 53 to hold the O-ring 52 therein. The outer peripheral surface of the upper portion of the diaphragm 8 is formed with a male screw portion 54, and a flange portion 55 in contact with the bottom of the first piston 6 is provided at the root of the male screw portion 54. The outer periphery of the flange portion 55 is formed with a membrane portion 56 adapted to be deflected vertically, and an annular fitting portion 57 having a substantially L-shaped cross section is formed at the peripheral edge of the membrane portion 56. The annular fitting portion 57 of the diaphragm 8 is fixedly held between the upper body 1 and the spring support 7, while at the same time being fixedly fitted in the annular groove 18 formed on the upper body 1 in a state where an O-ring 58 puts the annular fitting portion 57 in pressure contact with the annular groove 18. Also, the male screw portion 54 of the diaphragm 8 is coupled by the screw connection with the female screw portion 45 formed on the first piston 6 and the male screw portion 35 of the valve stem 4 inserted into the through-hole 51 of the first piston 8 is coupled by the screw connection with the female screw portion 44 formed on the first piston 6, so that the diaphragm 8 is fixedly held between the upper surface of the flange portion 36 of the valve stem 4 and the bottom of the first piston 6.

Reference numeral 9 designates a spring, which is held between the lower surface of the flange portion 43 formed on the first piston 6 and the bottom surface of the recess 46 formed on the spring support 7 to always urge the first piston 6 upward (i.e. in the direction away from the first valve chamber 16). In other words, in a situation where an external force is not applied, the valve stem 4 and the valve body 3 coupled to the first piston 6 are always urged upward, and the valve body 3 is in contact with the valve seat 22, that is to say, the valve is fully closed.

A through-hole 59 is formed at the center of the upper surface of the second cylinder 10. Also, a cylindrical protrusion 61 is provided on the lower surface of the second cylinder 10 and is fixedly fitted in the recess (i.e. the second cylinder chamber) 37 of the first cylinder 5 with an O-ring 60 held between the cylindrical protrusion 61 and the recess 37. A recess 62 is formed in the protrusion 61. Further, a second air port 63 communicating with the upper end of the recess 62 is formed on the side surface of the second cylinder 10.

A second piston 11 is disposed in the second cylinder 10 so as to be vertically slidable therein. The second piston 11 is formed to be hollow, and a flange portion 64 is formed on the outer periphery of the central portion of the second piston 11. An annular groove 66 for holding an O-ring 65 therein is formed on the outer peripheral surface of the flange portion 64. A cylindrical-shaped upper rod 67 is formed at the upper portion of the flange portion 64. The upper rod 67 is formed on the outer peripheral surface thereof with an annular groove 69 for holding an O-ring 68 therein and is adapted to be slidable up and down in the through-hole 59 of the second cylinder 10. A quadrangular prism-shaped lower rod 70 to be fitted into the through-hole 38 of the first cylinder 5 is formed under the flange portion 64, and is held in the through-hole 38 so as to be vertically movable but not rotatable. The inner peripheral surface of the lower rod 70 is formed with a female screw portion 71 which is continued to a through-hole 72 formed through the second piston 11. The length of the lower rod 70 is designed to be equal to the axial length of the through-hole 38. In other words, when the lower surface of the flange portion 64 of the second piston 11 comes into contact with the bottom surface of the recess 37 of the first cylinder 5, the lower end surface of the lower rod 70 becomes flush with the upper surface of the recess 39 of the first cylinder 5.

An adjustment screw 12 is inserted in the second piston 11. The outer peripheral surface of the lower portion of the adjustment screw 12 is formed with a male screw portion 73 adapted to engage the female screw portion 71 of the second piston 11, the outer peripheral surface of the center of the adjustment screw 12 is formed with an annular groove 75 for holding the O-ring 74 therein, and the outer peripheral surface of the upper portion of the adjustment screw 12 is formed with a male screw portion 76 adapted to engage a lock nut 14 described later. At the upper end of the adjustment screw 12, a handle 13 for rotating the adjustment screw 12 is fixed by a bolt 77. Thus, the adjustment screw 12 is movable vertically by rotating the handle 13.

Reference numeral 14 designates the lock nut. The inner peripheral surface of the lock nut 14 is formed with a female screw portion 78 adapted to engage the male screw portion 76 of the adjustment screw 12, the outer periphery of the lower portion of the lock nut 14 is formed with a cylindrical portion 79 which is smaller in diameter than the through-hole 59 so that it can move vertically in the through-hole 59 of the second cylinder 10, and the outer periphery of the upper portion of the lock nut 14 is formed with a flange portion 80 which is larger in diameter than the through-hole 59 of the second cylinder 10.

The base 15 is located under the lower body 2 and is fixedly secured to the lower body 2 by four nuts (not shown) mounted on the bottom surface of the base 15 and four bolts (not shown) extending through the base 15, the upper body 1, the lower body 2, the first cylinder 5 and the second cylinder 10.

According to the present invention, a fluorine resin such as polytetrafluoroethylene (hereinafter referred to as PTFE) or tetrafluoroethylene-perfluoro(alkyl vinyl ether) copolymer (hereinafter referred to as PFA) is suitably used for the members such as the upper body 1 and the lower body 2, because it has a superior chemical resistance and hardly elutes impurities. However, the used material is not specifically limited to these materials, and polyvinyl chloride, polypropylene or other plastics or metal may be used. As a material of the diaphragm 8, on the other hand, a fluoro resin such as PTFE or PFA is especially suitable. However, the material is not specifically limited to these materials, and rubber or metal may be used.

Next, the operation of the air-operated valve 100 according to this embodiment will be described.

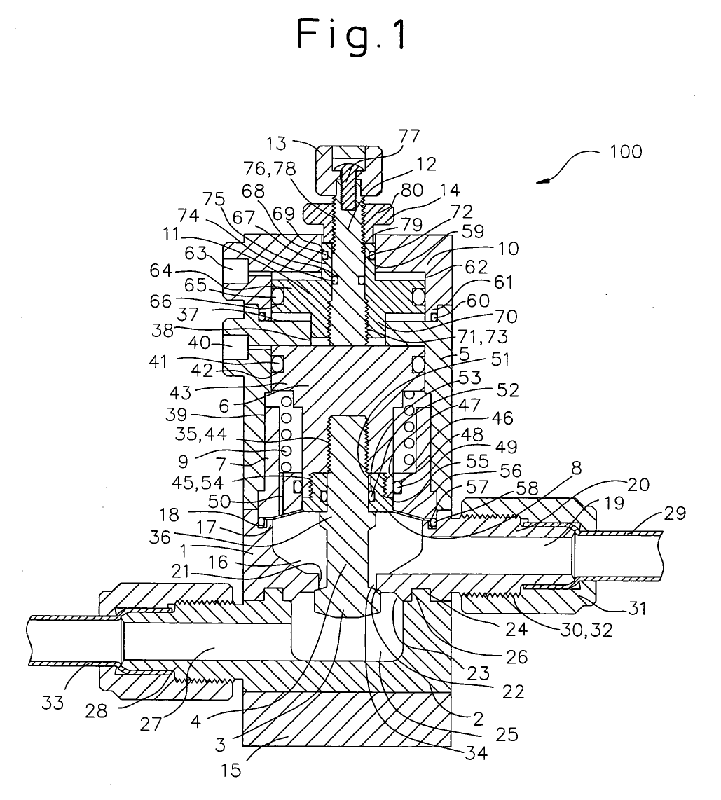

FIG. 1 shows the fully closed state of the valve, in which the working fluid such as air is injected into the valve from neither the first air port 40 nor the second air port 63. In other words, the first piston 6 is urged upward by the spring 9, and therefore the valve stem 4 and the valve body 3 coupled to and operated integrally with the first piston 6 are also urged upward, so that the valve body 3 comes into contact with the valve seat 22 to thereby fully close the valve. Under this condition, the fluid flows through the first flow passage 19, but cannot flow into the second flow passage 27 since the valve is fully closed.

In the fully closed state, the fluid pressure in the first valve chamber 16 is exerted on the valve body 3 and the diaphragm 8 as a force pushing the valve body 3 downward (i.e. in the direction away from the valve seat) and a force pushing the diaphragm 8 upward (i.e. in the direction away from the first valve chamber 16), respectively. As can be seen from the drawing, the pressure-receiving area of the diaphragm for receiving the fluid pressure in the first valve chamber 16 is designed to be larger than that of the valve body 3. Therefore, even under the normal fluid pressure, the force pushing the diaphragm 8 upward is larger than the force pushing the valve body 3 downward. On the other hand, as the valve body 3 and the diaphragm 8 are coupled integrally with each other through the valve stem 4, the valve body 3 is pushed upward, i.e. in such a direction as to be pressed into contact with the valve seat 22, thereby making it possible to maintain a high sealing performance. In the case where a higher fluid pressure is imparted, the force pushing the valve body 3 downward becomes larger, while the force pushing the diaphragm 8 upward also becomes larger so that the valve stem 4 and the valve body 3 coupled integrally with the diaphragm 8 are also strongly pushed upward. Therefore, a high sealing performance can be maintained and, even if the fluid pressure become higher or changes abruptly, the fluid is held without any leakage. Also in the case where the valve is used in the opposite direction of fluid flow, a superior sealing performance can be maintained because the valve body 3 and the diaphragm 8 are both urged upward by the fluid pressure.

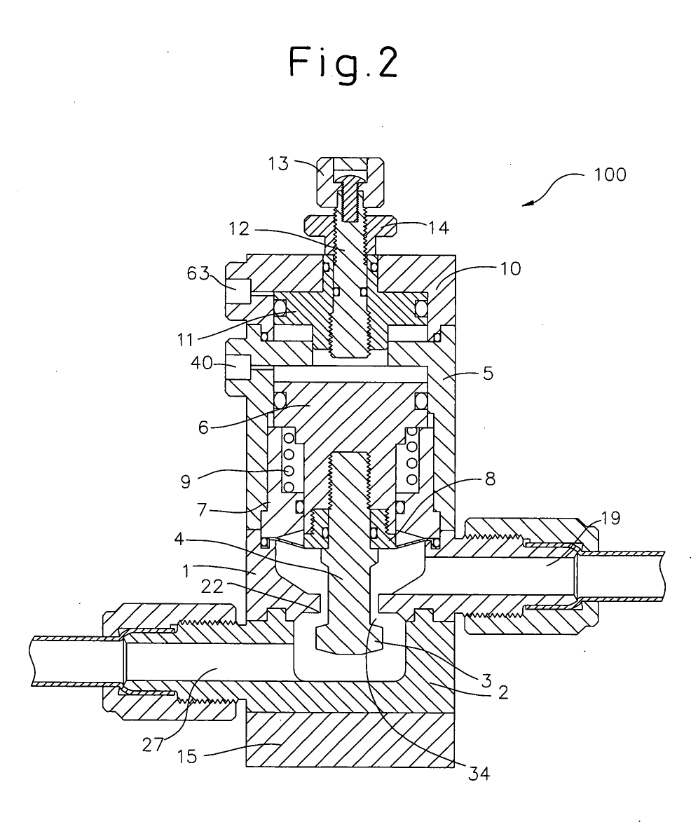

In the state shown in FIG. 1, when the working fluid is not injected from the second air port 63 of the second cylinder 10 but from the first air port 40 of the first cylinder 5, the first piston 6 is pushed down by the pressure of the working fluid and, at the same time, the valve stem 4 and the valve body 3 are pushed down. Thus, the valve body 3 comes away from the valve seat 22, resulting in the state where the valve is opened so that the fluid flows out of the first flow passage 19 into the second flow passage 27. The downward movement of the first piston 6 is stopped at a point where the lower surface of the flange portion 43 comes into contact with the upper surface of the spring support 7. At this time, the valve is in the fully opened state (the state shown in FIG. 2). When the working fluid that has thus far been injected from the first air port 40 is discharged, the first piston 6 is pushed up by the force of the spring 9 again, and the valve becomes the fully closed state again (the state shown in FIG. 1) at a point where the valve body 3 comes into contact with the valve seat 22.

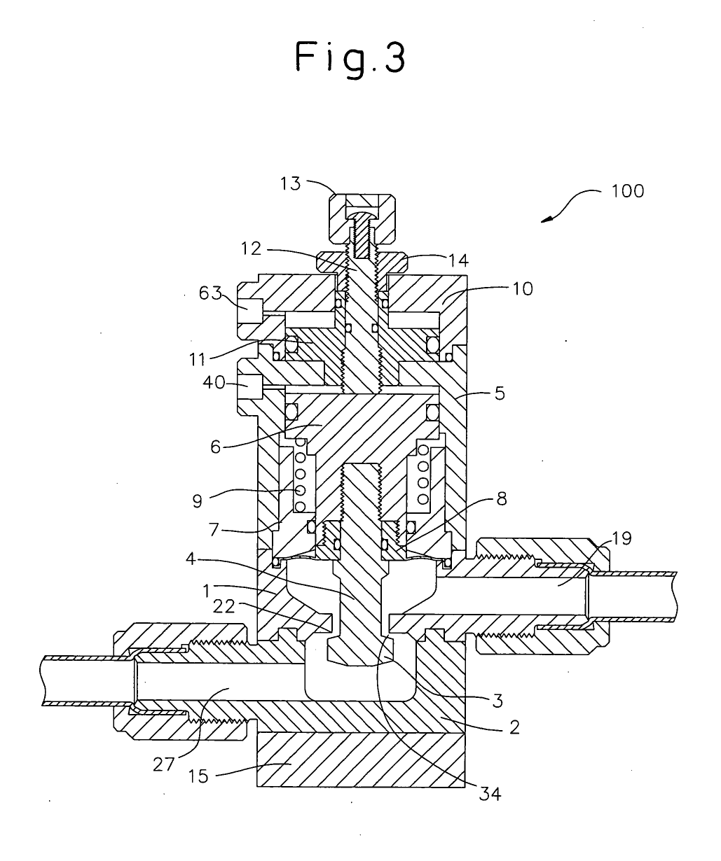

Next, a method of holding the valve at the intermediate opening degree will be described. When the working fluid such as air is not injected from the first air port 40 of the first cylinder 5 but from the second air port 63 of the second cylinder 10, the second piston 11 is pushed down by the pressure of the working fluid, and the lower surface of the flange portion 64 of the second piston 11 comes into contact with the bottom surface of the recess 37 of the first cylinder 5 and becomes flush with the upper surface of the recess 39 of the second piston 11. In the process, if the adjustment screw 12 engaging the second piston 11 is projected by an arbitrary length from the lower surface of the second piston 11 by rotating the handle 13, the lower surface of the adjustment screw 12 pushes down the upper surface of the first piston 6 by the length equal to the projection from the lower surface of the second piston 11, and therefore the valve body 3 coupled to the first piston 6 moves away from the valve seat 22 so that the valve becomes the intermediate opening degree state (the state shown in FIG. 3). The flow rate at the intermediate opening degree depends on the area of the opening 34 between the valve body 3 and the valve seat 22, i.e. the length by which the adjustment screw 12 is projected from the lower surface of the second piston 11. Therefore, by rotating the handle 13, the flow rate at the intermediate opening degree can be set as desired. At this time, if the lock nut 14 is rotated so that the bottom surface thereof is brought into contact with the upper surface of the second piston 11 and fixed and the adjustment screw 12 is completely fixed in position, a problem such as the flow rate at the intermediate opening degree undesirably changing by the unintentional rotation of the handle 13 due to the vibration of the pump or accidental contact with the handle 13 is prevented.

As in the fully opened state, when the working fluid that has thus far been injected from the second air port 63 is discharged, the first piston 6 is pushed up again by the force of the spring 9 so that the valve becomes the closed state again (the state shown in FIG. 1).

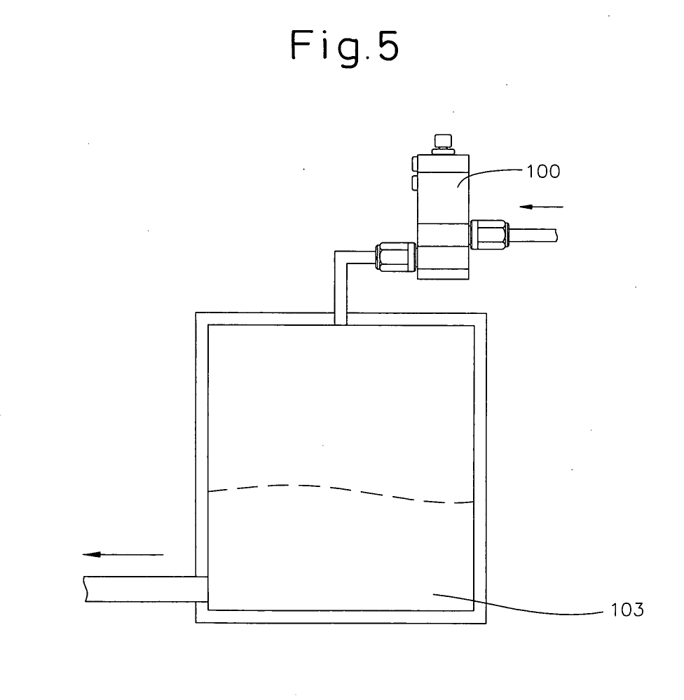

In the case of this embodiment, for example, in order to feed a predetermined amount of a chemical liquid or the like fluid into the tank 103 with a high accuracy, as shown in FIG. 5, the working fluid is, at the initial stage, injected from the first air port 40, i.e. fed at a large flow rate with the valve fully opened, while the pressure of the working fluid is, at the last stage, released through the first air port 40, and the working fluid is injected from the second air port 63, i.e. the valve is set to the intermediate opening degree, to thereby finely adjust the total volume. Once the predetermined amount of the fluid has been fed, the pressure of the working fluid of the second air port 63 is released, i.e., the valve is fully closed, to thereby stop the fluid supply.

In another application, for example, in the case where the valve is used the pure water line, if the valve is set to the intermediate opening degree as in this embodiment, a small amount of water can be always kept flowing without being stopped. This makes it possible to suppress the growth of microorganisms due to stagnation of the fluid.

In this embodiment, when the working fluid is injected into neither the first air port 40 nor the second air port 63, the valve is closed. Therefore, even in the case of emergency such as when the supply of the working fluid is stopped by some external trouble, the valve is kept in the closed state and no fluid flows through the valve.

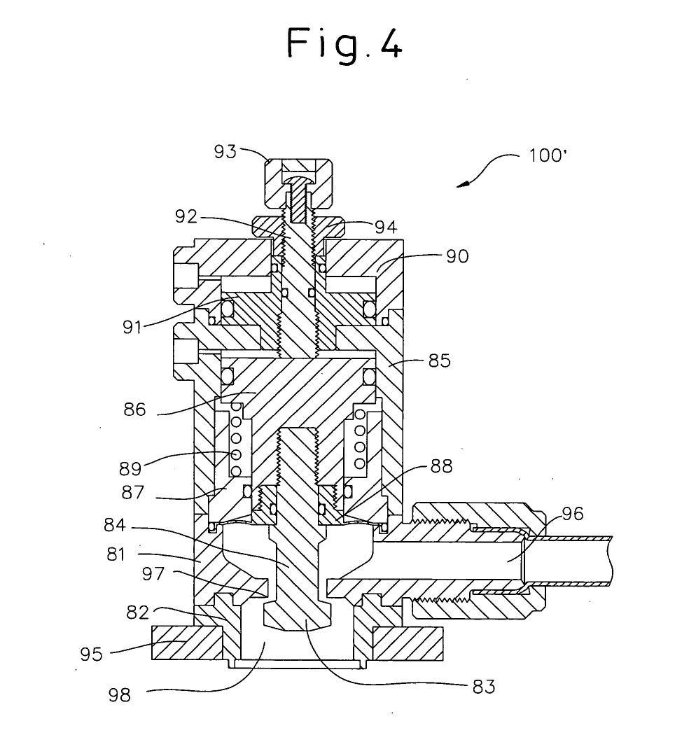

FIG. 4 shows another embodiment of the present invention. The air-operated valve 100 shown in FIG. 4 includes an upper body 81 formed with a first valve chamber communicating with a first flow passage 96 and a valve seat 97, a lower body 82, a valve body 83, a valve stem 84, a first cylinder 85, a first piston 86, a spring support 87, a diaphragm 88, a spring 89, a second cylinder 90, a second piston 91, an adjustment screw 92, a handle 93, a lock nut 94 and a base 95. This embodiment is different from the first embodiment in that a second flow passage 98 is formed in the bottom of the lower body 82 to extend through the base 95. The respective parts and the operation thereof are the same as those of the first embodiment and not described in detail. For example, in the case where this embodiment is used in a pipe line as shown in FIG. 5, which was referred to when the first embodiment was described, the fact that the second flow passage 98 is formed in the bottom of the lower body 82 makes it possible to place the valve directly on the tank 103 with bolts (not shown). Thus, the piping work can be simplified, and the space required for piping can be decreased to thereby reduce the cost for the piping materials.

Although the second valve chamber and the second flow passage 98 have the same diameter and are in communication with each other in this embodiment, the profile is not specifically limited and a joint may be formed integrally on the bottom as in the first embodiment.

The air-operated valves according to the two embodiments described above have the structure described above and, by use of this structure, the following effects can be achieved.

(1) Simply by switching the working fluid, the valve opening degree can be easily adjusted and held to any of three stages including the fully closed state, fully opened state and the arbitrary intermediate opening degree state. Also, in case of emergency, the valve is fully closed and therefore the fluid is prevented from flowing out.

(2) Even in a situation where the fluid pressure can become high or change abruptly, the fluid is prevented from leaking, and a superior sealing performance can be exhibited.

(3) The intermediate opening degree can be set by only the operation of the intermediate opening degree adjustment mechanism and, therefore, the desired flow rate can be easily achieved.

(4) When the valve is used in pure water line or the like, the valve can be operated so that the fluid always flows through the valve by using the intermediate opening degree. Thus, the valve can be used as a bypass valve to prevent bacteria, etc. from growing.

(5) In the case where a fluid such as a chemical liquid is fed to a tank, the second flow passage formed in the bottom of the lower body makes it possible to place the valve directly on the tank. This can not only simplify the piping work but also decrease the piping space to thereby reduce the cost for piping materials.

Although the present invention has been described above with reference to several embodiments shown in the accompanying drawings, these embodiments are only illustrative and not limitative. Also, the scope of the present invention is defined by the appended claims and the present invention can be modified or changed without departing from the scope of the claims.

1. A fluid-operated valve comprising:
a valve housing;
a first valve chamber and a second valve chamber formed in said valve housing and communicating with each other through a through-hole;
a first cylinder chamber formed adjacent to said first valve chamber in said valve housing;
a first piston accommodated in said first cylinder chamber so as to be slidable therein;
a valve body positioned in said second valve chamber and adapted to come into contact with or move away from said valve seat formed at the edge of said through-hole to thereby establish or shut off communication between said first valve chamber and said second valve chamber;
a valve stem extending through said through-hole and said first valve chamber and having one end connected to said first piston and the other end connected to said valve body;
an annular diaphragm having an inner peripheral portion fixed to a peripheral surface of said valve stem and an outer peripheral portion fixed to an inner peripheral surface of said first valve chamber; and
a spring for urging said first piston away from said first valve chamber to bring said valve body into contact with said valve seat,
wherein, by supplying the working fluid into one of spaces separated from each other in said first cylinder chamber by said first piston which one space is far from said first valve chamber, said first piston is moved toward said first valve chamber to move said valve body away from said valve seat, thereby allowing the fluid to flow between said first valve chamber and said second valve chamber.

2. The fluid-operated valve according to claim 1, wherein a pressure-receiving area of said diaphragm for receiving the pressure of the fluid in said first valve chamber is designed to be larger than that of said valve body.

3. The fluid-operated valve according to claim 1, further comprising a second cylinder chamber formed adjacent to said first cylinder chamber on the side thereof far from said first valve chamber in said valve housing, a second piston accommodated in the second cylinder chamber so as to be slidable therein, and an adjustment screw extending through said second piston and said second cylinder chamber so that one end thereof is positioned in said first cylinder chamber and the other end thereof is positioned outside the valve housing, said adjustment screw mounted on said second piston so that the amount of projection from said second piston can be adjusted, wherein, by supplying the working fluid into one of spaces separated from each other in said second cylinder chamber by said second piston which one space is far from said first cylinder chamber, said one end of said adjustment screw is brought into contact with said first piston to move said first piston toward said first valve chamber, thereby moving said valve body away from said valve seat.

4. The fluid-operated valve according to claim 2, further comprising a second cylinder chamber formed adjacent to said first cylinder chamber on the side thereof far from said first valve chamber in said valve housing, a second piston accommodated in the second cylinder chamber so as to be slidable therein, and an adjustment screw extending through said second piston and said second cylinder chamber so that one end thereof is positioned in said first cylinder chamber and the other end thereof is positioned outside the valve housing, said adjustment screw mounted on said second piston so that the amount of projection from said second piston can be adjusted, wherein, by supplying the working fluid into one of spaces separated from each other in said second cylinder chamber by said second piston which one space is far from said first cylinder chamber, said one end of said adjustment screw is brought into contact with said first piston to move said first piston toward said first valve chamber, thereby moving said valve body away from said valve seat.

5. The fluid-operated valve according to claim 1, wherein said second valve chamber is formed in the bottom portion of said valve housing.

6. The fluid-operated valve according to claim 2, wherein said second valve chamber is formed in the bottom portion of said valve housing.

7. The fluid-operated valve according to claim 3, wherein said second valve chamber is formed in the bottom portion of said valve housing.
